(19) United States
(12) Patent Application Publication
(10) Pub. No.: US 2025/0244927 A1
(43) Pub. Date: Jul. 31, 2025

(54) DEVICE AND METHOD FOR CONTROLLING THE SAME, AND STORAGE MEDIUM

(71) Applicant: CANON KABUSHIKI KAISHA, Tokyo (JP)

(72) Inventor: Ritsuto Sako, Tokyo (JP)

(21) Appl. No.: 19/036,345

(22) Filed: Jan. 24, 2025

(30) Foreign Application Priority Data
Jan. 31, 2024 (JP) 2024-013309

(51) Int. Cl. G06F 3/12

(52) U.S. Cl. CPC G06F 3/1238; G06F 3/1222; G06F 3/1287

(57) ABSTRACT

A device that connects, via a network, to a cloud print server system that handles cloud printing services and cloud scanning services, the device comprises a transmission unit configured to transmit, to the cloud print server system, a registration request including a device type included in the device among cloud printing functions and cloud scanning functions; and an acquisition unit configured to acquire, from the cloud print server system, an access token for a service enabled by a setting unit among the cloud printing services and the cloud scanning services.

### BACKGROUND OF THE INVENTION

### Field of the Invention

The present invention relates to a device and a method for controlling the same and a storage medium.

### Description of the Related Art

Known printing services have realized printing by a user directly transmitting a print job from a client terminal such as a PC to a multi function peripheral. Japanese Patent Laid-Open No. 2023-71252 proposes a cloud printing service using a cloud service handled on the Internet.

As described in Japanese Patent Laid-Open No. 2022-136867, Mopria Alliance Technical Working Group eSCL Technical Specification, Ver2.9, Mar. 22, 2021, Approved by the Mopria Board (URL=https://mopria.org/mopria-escl-specification), there are known multi function peripherals compatible with local scanning functions.

When registering a device in a cloud device registration service in known cloud printing, it has not been possible to judge whether or not the registered device is a device compatible with cloud scanning having cloud scanning functions. Therefore, it has not been able to use, as a cloud scanning device, the device registered in the cloud device registration service.

### SUMMARY OF THE INVENTION

The present invention enables realization of a technology of using, as a cloud scanning device, a device registered in a cloud device registration service.

One aspect of the present invention provides a device that connects, via a network, to a cloud print server system that handles cloud printing services and cloud scanning services, the device comprising: a transmission unit configured to transmit, to the cloud print server system, a registration request including a device type included in the device among cloud printing functions and cloud scanning functions; and an acquisition unit configured to acquire, from the cloud print server system, an access token for a service enabled by a setting unit among the cloud printing services and the cloud scanning services.

Another aspect of the present invention provides a method for controlling a device that connects, via a network, to a cloud print server system that handles cloud printing services and cloud scanning services, the method comprising: transmitting a registration request including a device type included in the device among cloud printing functions and cloud scanning functions to the cloud print server system that handles the cloud printing services and the cloud scanning services; and acquiring, from the cloud print server system, an access token for a service enabled by a setting unit among the cloud printing services and the cloud scanning services.

Still another aspect of the present invention provides a non-transitory computer-readable storage medium, the storage medium storing a program for causing a computer to execute each step of controlling a device that connects, via a network, to a cloud print server system that handles cloud printing services and cloud scanning services, the method comprising: transmitting a registration request including a device type included in the device among cloud printing functions and cloud scanning functions to the cloud print server system that handles the cloud printing services and the cloud scanning services; and acquiring, from the cloud print server system, an access token for a service enabled among the cloud printing services and the cloud scanning services.

Further features of the present invention will become apparent from the following description of exemplary embodiments (with reference to the attached drawings).

### BRIEF DESCRIPTION OF THE DRAWINGS

FIG. 1 is a cloud printing registration sequence diagram of a multi function peripheral.

FIG. 2 is a cloud printing startup sequence diagram of the multi function peripheral.

FIG. 3 is a cloud printing print sequence diagram of the multi function peripheral.

FIG. 4 is a sequence diagram of startup and printing of local scanning functions of the multi function peripheral.

FIG. 5 is a hardware configuration diagram of the multi function peripheral in one example.

FIG. 6 is a software configuration diagram of the multi function peripheral in one example.

FIG. 7 is an operation panel explanatory diagram of the multi function peripheral in one example.

FIG. 8 is a hardware configuration diagram of a cloud print server in one example.

FIG. 9 is a software configuration diagram of the cloud print server in one example.

FIG. 10 is a cloud device registration sequence diagram of the multi function peripheral in one example.

FIG. 11 is a startup sequence diagram of the multi function peripheral in one example.

FIG. 12 is a cloud printing print sequence diagram of the multi function peripheral in one example.

FIG. 13 is a scan sequence diagram of cloud scanning of the multi function peripheral in one example.

FIG. 14 is a diagram illustrating a device type that the multi function peripheral in one example transmits at the time of cloud device registration.

FIG. 15 is a flowchart showing cloud device registration processing of the multi function peripheral in one example.

FIG. 16 is a flowchart showing processing when a cloud device registration service in one example receives a registration request.

FIGS. 17A to 17D are views illustrating settings in a UI of the multi function peripheral in one example.

FIG. 18 is a flowchart when cloud printing settings of the multi function peripheral in one example are changed.

FIG. 19 is a flowchart when cloud scanning settings of the multi function peripheral in one example are changed.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

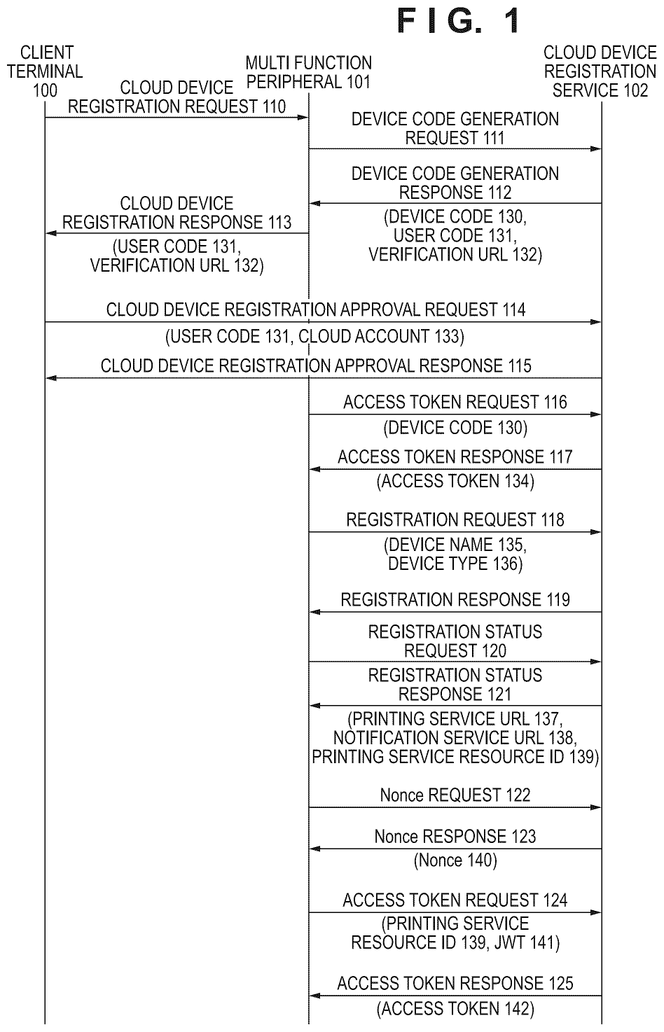

An operation sequence of cloud printing will be described with reference to FIGS. 1 to 3.

FIG. 1 is a cloud printing registration sequence diagram of the multi function peripheral.

A multi function peripheral 101 is assumed to support cloud printing functions and WebUI functions for operating the multi function peripheral 101. A client terminal 100 is assumed to support cloud printing client functions and a WebUI client for operating the WebUI. A cloud device registration service 102 is assumed to be a service on the Internet handled by a cloud print server.

The user first uses a WebUI client of the client terminal 100 to transmit a request 110 for cloud device registration to the multi function peripheral 101 via the WebUI. Upon receiving the request 110, the multi function peripheral 101 transmits a device code generation request 111 to a cloud device registration service 102. Upon receiving the request 111, the cloud device registration service 102 transmits a device code generation response 112 to the multi function peripheral 101. The device code generation response 112 includes a device code 130, a user code 131, and a verification URL 132 generated by the cloud device registration service 102. Upon receiving the device code generation response 112, the multi function peripheral 101 transmits a cloud device registration response 113 to the client terminal 100. The cloud device registration response 113 includes the user code 131 and the verification URL 132 generated by the cloud device registration service 102.

Upon receiving the cloud device registration response 113, the client terminal 100 displays the user code 131 and the verification URL 132 on the WebUI client. The user operates the WebUI client to access the verification URL 132 that is displayed. Then, by inputting a cloud account 133 and the user code 131, a cloud device registration approval request 114 is transmitted to the cloud device registration service 102. Upon receiving the cloud device registration approval request 114, the cloud device registration service 102 associates the cloud device registration approval request 114 with, as the cloud account 133, an administrator of the multi function peripheral 101 that is registered, and manages the multi function peripheral 101 as having been approved for the registration. The cloud device registration service 102 then transmits a cloud device registration approval response 115 to the client terminal 100.

The multi function peripheral 101 transmits an access token request 116 to the cloud device registration service 102. The access token request 116 includes the device code 130 generated by the cloud device registration service 102. Upon receiving the access token request 116, the cloud device registration service 102 generates an access token 134. This access token 134 is used in subsequent registration processing and certifies authorization of the registration processing. The cloud device registration service 102 transmits an access token response 117 to the multi function peripheral 101. The access token response 117 includes the access token 134 generated by the cloud device registration service 102.

The multi function peripheral 101 transmits a registration request 118 to the cloud device registration service 102. The registration request 118 includes a device name 135 and a device type 136. The access token 134 is added to an HTTP header of the registration request 118. The device name 135 is a device name set in the multi function peripheral 101. The device type 136 represents a device type of the multi function peripheral 101, and “printer” is set in a cloud printing service 200. The cloud printing service 200 is assumed to be a service on the Internet handled by the cloud print server. Upon receiving the registration request 118, the cloud device registration service 102 determines whether or not the access token 134 is a token to which the cloud device registration service 102 itself has responded with the access token response 117. This confirms whether the transmitted registration request 118 is an authorized registration request. Upon determining that the registration request 118 is an authorized registration request as a result of the confirmation, the cloud device registration service 102 transmits a registration response 119 to the multi function peripheral 101 and starts registration processing of the multi function peripheral 101.

The multi function peripheral 101 transmits a registration status request 120 to the cloud device registration service 102. Also in the registration status request 120, the access token 134 is added to the HTTP header. Upon receiving the registration status request 120, the cloud device registration service 102 confirms the access token 134 in the same manner as when receiving the registration request 118. Upon determining that the registration request is an authorized registration request, the registration status request 120 continues the following processing. When the registration is completed, the cloud device registration service 102 transmits a registration status response 121 to the multi function peripheral 101. The access token response 117 includes a printing service URL 137, a notification service URL 138, and a printing service resource ID 139. The printing service URL 137 is end point information indicating an end point of the cloud printing service 200. The notification service URL 138 is end point information indicating an end point of a cloud printing event notification service 201. The printing service resource ID 139 is unique information generated by the cloud device registration service for acquiring an access token for using the printing service. The cloud printing event notification service 201 is assumed to be a service on the Internet handled by the cloud print server.

Next, the multi function peripheral 101 acquires an access token for using the cloud printing service 200. The multi function peripheral 101 transmits a Nonce request 122 to the cloud device registration service 102. The Nonce is random data valid only once for use in authentication. Upon receiving the Nonce request 122, the cloud device registration service 102 generates a Nonce 140 and transmits a Nonce response 123 to the multi function peripheral 101. The Nonce response 123 includes the Nonce 140.

Upon acquiring the Nonce 140 in the Nonce response 123, the multi function peripheral 101 generates a JSON Web Token (JWT) 141. The JWT is authentication information expressed in a JSON format encoded with Base64 added with a signature. Then, the multi function peripheral 101 transmits an access token request 124 to the cloud device registration service 102. The access token request 124 includes the printing service resource ID 139 received from the cloud device registration service 102 and the JWT 141 generated by the multi function peripheral 101.

Upon receiving the access token request 124, the cloud device registration service 102 verifies the Nonce 140 that is generated and the JWT 141 received from the multi function peripheral 101 to authenticate the multi function peripheral 101. Based on the printing service resource ID 139 included in the access token request 124, the cloud device registration service 102 generates an access token 142, and transmits an access token response 125 to the multi function peripheral 101. The access token response 125 includes the access token 142.

The cloud device registration processing of the multi function peripheral 101 is completed by this point.

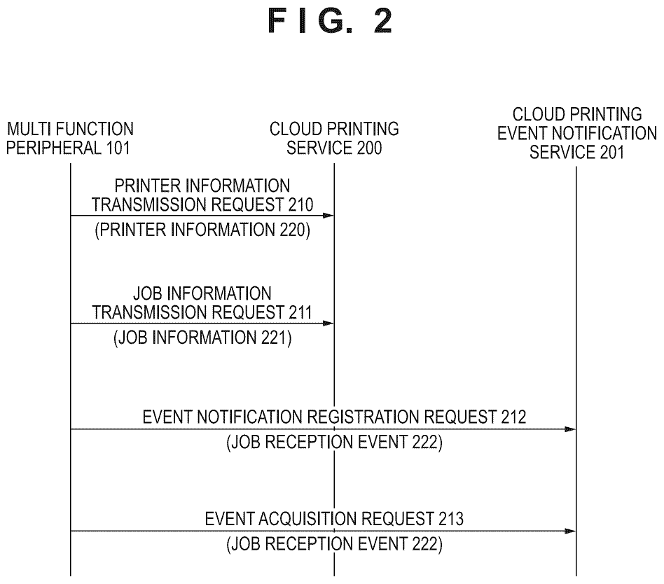

Next, FIG. 2 will be described. FIG. 2 is a cloud printing startup sequence diagram of the multi function peripheral. A description will be given on an assumption that the communication of the present sequence uses Internet Printing Protocol (IPP), which is a printing protocol using HTTP.

The multi function peripheral 101 transmits a printer information transmission request 210 to the cloud printing service 200. The IPP operation is Update-Output-Device-Attributes. The printer information transmission request 210 includes printer information 220. The printer information 220 is information expressed by printer-description, which is an attribute group of IPP.

The multi function peripheral 101 transmits a job information transmission request 211 to the cloud printing service 200. The IPP operation is Update-Active-Jobs. The job information transmission request 211 includes job information 221. The job information 221 includes job-ids and output-device-job-states, which are IPP attributes. job-ids indicates an ID of a job, and output-device-job-states indicates a status of the job.

The multi function peripheral 101 transmits an event notification registration request 212 to the cloud printing event notification service 201. The IPP operation is Create-Printer-Subscription. The event notification registration request 212 includes a job reception event 222 indicating the type of the event to be notified. The job reception event 222 includes job-fetchable, which is an IPP attribute. job-fetchable is an event type indicating that a receivable job exists in the cloud printing service.

The multi function peripheral 101 transmits an event acquisition request 213 to the cloud printing event notification service 201. The IPP operation is Get-Notifications. The event acquisition request 213 includes the job reception event 222 as the type of the event to be acquired. The job reception event 222 includes job-fetchable, which is an IPP attribute.

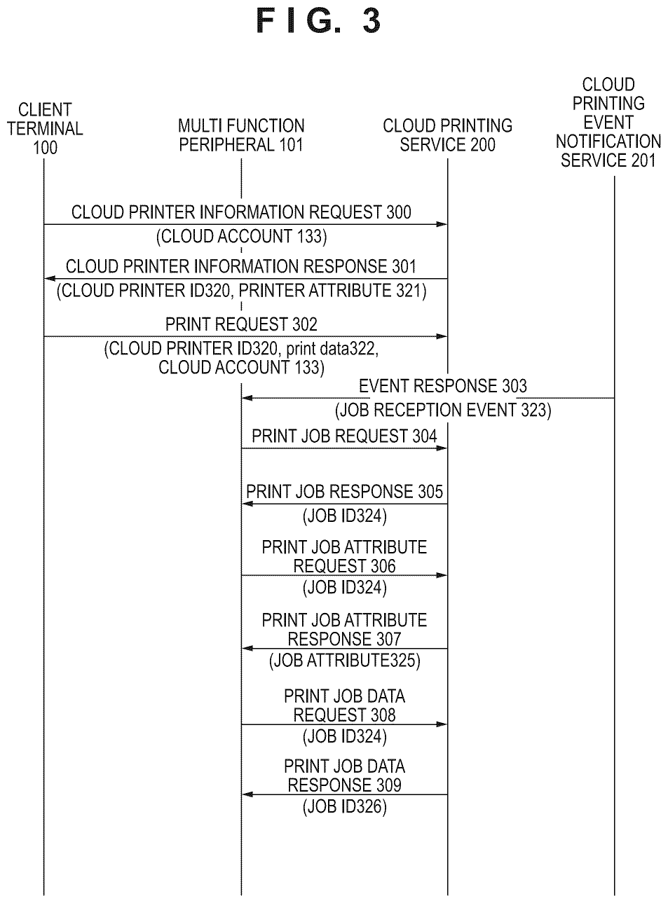

Next, FIG. 3 will be described. FIG. 3 is a sequence diagram of cloud printing print of the multi function peripheral. The description will be given on an assumption that the communication of the multi function peripheral 101 in the present sequence uses IPP, which is a printing protocol using HTTP.

The client terminal 100 transmits a cloud printer information request 300 to the cloud printing service 200. The cloud printer information request 300 includes the cloud account 133. Upon receiving the cloud printer information request 300, the cloud printing service 200 transmits a cloud printer information response 301 to the client terminal 100. The cloud printer information response 301 includes a cloud printer ID 320 permitted to be used by the cloud account 133 and a printer attribute 321 indicating the capability of the printer.

The client terminal 100 transmits a print request 302 to the cloud printing service 200 in response to the print operation of the user. The print request 302 includes the cloud printer ID 320 for specifying the printer, print data 322, and the cloud account 133 for specifying the user.

Upon detects that a print job addressed to the multi function peripheral 101 has been generated in the cloud printing service 200, the cloud printing event notification service 201 transmits an event response 303 to the multi function peripheral 101. The event response 303 includes a job reception event 323 as an event type. The IPP operation is Get-Notifications Response. The job reception event 323 includes job-fetchable, which is an IPP attribute.

Upon receiving the event response 303, the multi function peripheral 101 transmits a print job request 304 to the cloud printing service 200. The IPP operation is Get-Jobs.

Upon receiving the print job request 304, the cloud printing service 200 transmits a print job response 305 to the multi function peripheral 101. The IPP operation is Get-Job Response. The print job response 305 includes a job ID 324 indicating a downloadable job.

Upon receiving the print job response 305, the multi function peripheral 101 transmits a print job attribute request 306 to the cloud printing service 200. The IPP operation is Fetch-Job. The print job attribute request 306 includes a job ID 324 designating a target job.

Upon receiving the print job attribute request 306, the cloud printing service 200 transmits a print job attribute response 307 to the multi function peripheral 101. The IPP operation is Fetch-Job Response. The print job attribute response 307 includes a job attribute 325 of the job ID 324. The job attribute 325 is information expressed by Job-Template-attributes, which is an IPP attribute group.

Upon receiving the print job attribute response 307, the multi function peripheral 101 transmits a print job data request 308 to the cloud printing service 200. The IPP operation is Fetch-Document. The print job data request 308 includes a job ID 324 designating a target job.

Upon receiving the print job data request 308, the cloud printing service 200 transmits a print job data response 309 to the multi function peripheral 101. The IPP operation is Fetch-Document Response. The print job data response 309 includes job data 326 of the job ID 324.

The operation sequence of cloud printing has been described so far. Hereinafter, the local scanning functions of the multi function peripheral will be described.

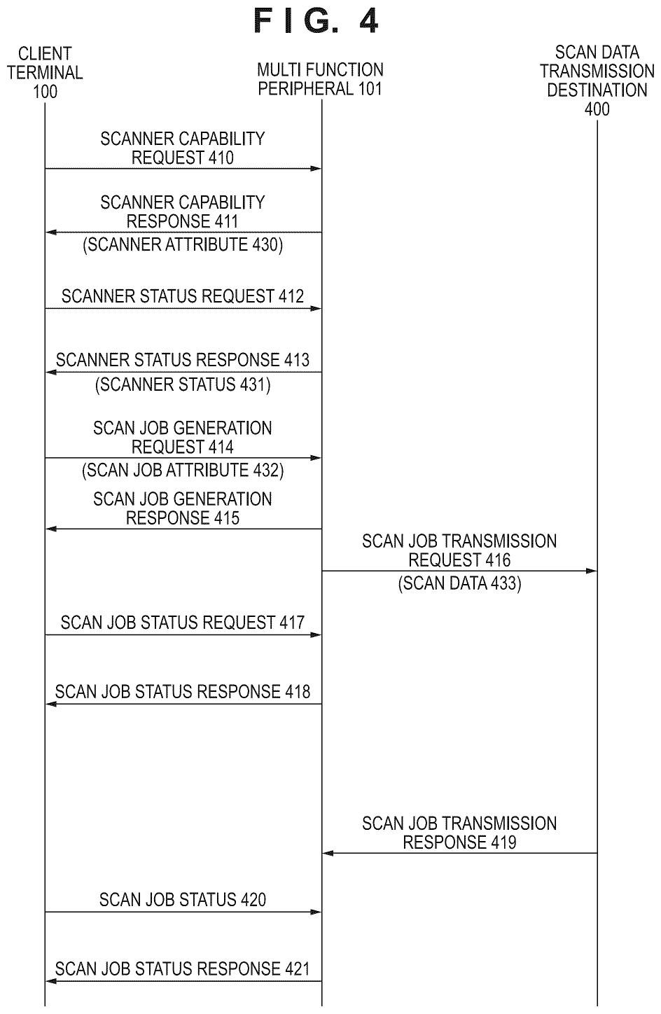

FIG. 4 is a scan sequence diagram of the local scanning functions of the multi function peripheral. The description will be given on an assumption that the communication of the multi function peripheral 101 in the present sequence uses eSCL, which is a scanning protocol using HTTP.

The client terminal 100 transmits a scanner capability request 410 to the multi function peripheral 101. The eSCL operation is ScannerCapabilities. Upon receiving the capability request 410, the multi function peripheral 101 transmits a scanner capability response 411 to the client terminal 100. The eSCL operation is ScannerCapabilities Response. The scanner capability response 411 includes a scanner attribute 430. The scanner attribute 430 is information indicating the capability of the scanner expressed in XML.

The client terminal 100 transmits a scanner status request 412 to the multi function peripheral 101. The eSCL operation is ScannerStatus. Upon receiving the scanner status request 412, the multi function peripheral 101 transmits a scanner status response 413 to the client terminal 100. The eSCL operation is ScannerStatus Response. The scanner status response 413 includes a scanner status 431. The scanner status 431 is information indicating the status of the scanner expressed in XML.

The client terminal 100 transmits a scan job generation request 414 to the multi function peripheral 101. The eSCL operation is ScanJobs. The scan job generation request 414 includes a scan job attribute 432. The scan job attribute 432 is information indicating a scan job attribute expressed in XML. The information indicating the scan job attribute also includes transmission destination information of the job scanned by the multi function peripheral 101. Upon receiving the scan job generation request 414, the multi function peripheral 101 transmits a scan job generation response 415 to the client terminal 100. The eSCL operation is ScanJobs Response.

Upon receiving the scan job generation request 414, the multi function peripheral 101 starts scan processing. The multi function peripheral 101 transmits a scan job transmission request 416 to a scan data transmission destination 400. The scan job transmission request 416 includes scan data 433 scanned by the multi function peripheral 101. The scan data transmission destination 400 is designated from the client terminal 100 in a form of being included in the scan job attribute 432. Note that a protocol determined between the scan job transmission request 416 and the scan data transmission destination 400 is used for the scan job transmission request 416. The eSCL is not necessarily used.

The client terminal 100 transmits a scan job status request 417 to the multi function peripheral 101. The eSCL operation is ScannerStatus. Upon receiving the scan job status request 417, the multi function peripheral 101 transmits a scan job status response 418 to the client terminal 100. The eSCL operation is ScannerStatus Response. The scan job status response 418 includes information indicating the status of the scan job in a format expressed in XML.

Upon receiving the scan data 433 by the scan job transmission request 416, the scan data transmission destination 400 transmits a scan job transmission response 419 to the multi function peripheral 101.

The client terminal 100 periodically transmits a scan job status request 420 to the multi function peripheral 101. The eSCL operation is ScannerStatus. Upon receiving the scan job status request 420, the multi function peripheral 101 transmits a scan job status response 421 to the client terminal 100. Here, when the scan job transmission response 419 is received from the scan data transmission destination 400 and the transmission of the scan data is normally completed, the scan job status response 421 includes, in a format expressed in XML, information indicating completion as the status of the scan job. Note that a protocol determined between the scan job transmission response 419 and the scan data transmission destination 400 is used for the scan job transmission response 419. The eSCL is not necessarily used.

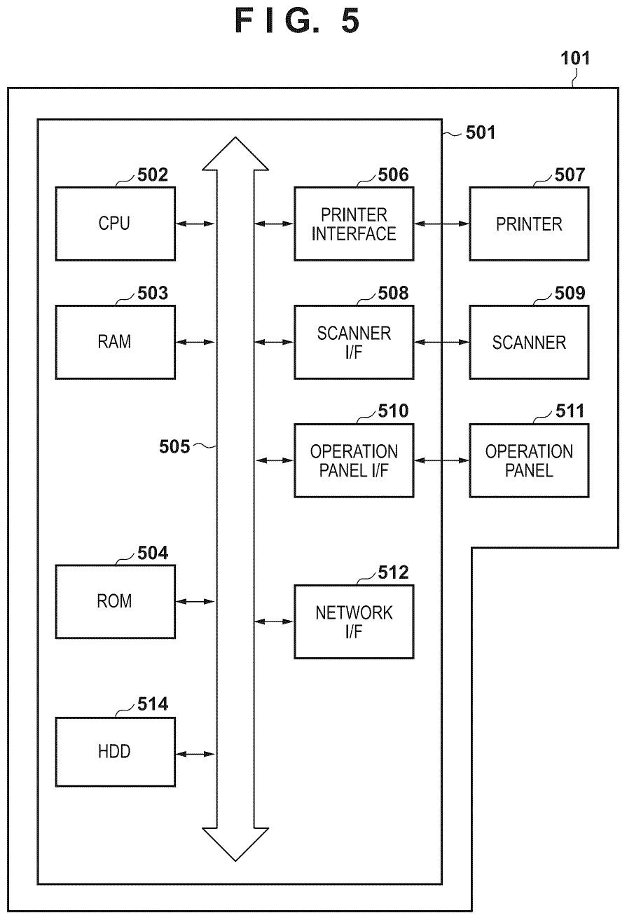

Next, a hardware configuration of the multi function peripheral 101 according to the present invention will be described with reference to FIG. 5. The multi function peripheral 101 includes a control unit 501, a printer 507, a scanner 509, and an operation panel 511. The control unit 501 includes a CPU 502, a RAM 503, a ROM 504, an HDD 514, a printer I/F 506, a scanner I/F 508, an operation panel I/F 510, and a network I/F 512. The blocks in the control unit 501 are connected by a system bus 505.

The control unit 501 including the CPU 502 controls the entire operation of the multi function peripheral 101. The CPU 502 reads, to the RAM 503, control programs stored in the ROM 504 and performs various types of control such as communication control. The RAM 503 is used as a temporary storage area such as a main memory and a work area of the CPU 502. The HDD 514 stores data, various programs, or various information tables.

The printer I/F 506 serves as an interface for outputting an image signal to the printer 507 (printer engine). The scanner I/F 508 also serves as an interface for inputting a read image signal from the scanner 509 (scanner engine). The CPU 502 processes the image signal input from the scanner I/F 508, and outputs the processed image signal to the printer I/F 506 as a recorded image signal.

The operation panel I/F 510 connects the operation panel 511 and the control unit 501. The operation panel 511 includes a liquid crystal display unit having a touch panel function, and a keyboard.

The network I/F 512 transmits information to external terminals such as the client terminal 100 and the cloud printing service 200, or receives various types of information from the external devices.

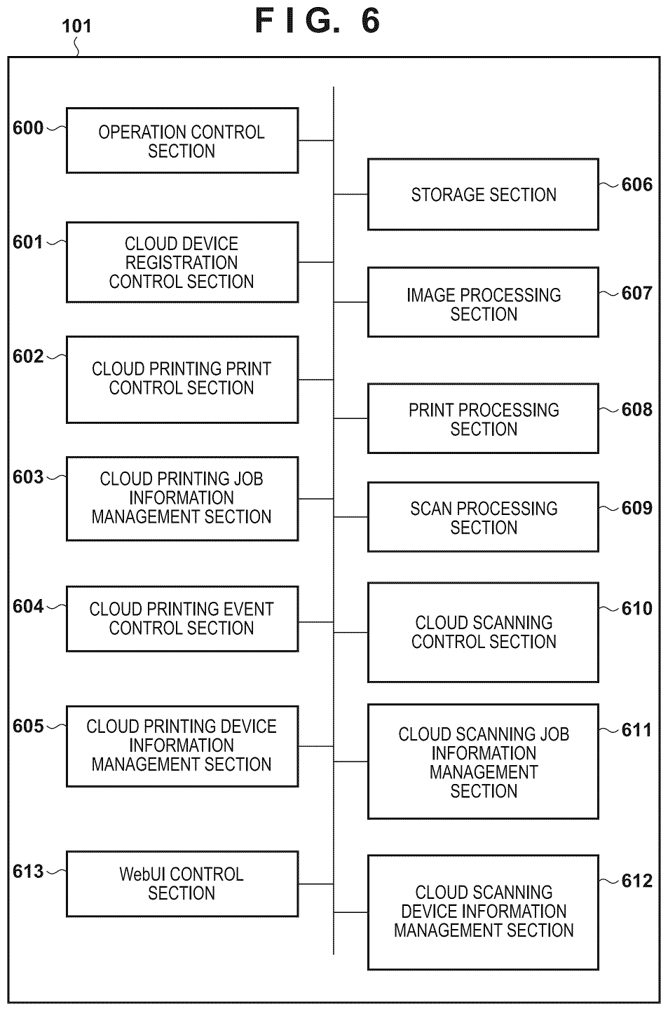

The software configuration of the multi function peripheral 101 will be described with reference to FIG. 6. Each functional unit illustrated in FIG. 6 is realized by the CPU 502 of the multi function peripheral 101 reading control programs stored in the ROM 504 into the RAM 503 and executing the control programs. The software of the multi function peripheral 101 includes an operation control section 600, a cloud device registration control section 601, a cloud printing print control section 602, a cloud printing job information management section 603, a cloud printing event control section 604, a cloud printing device information management section 605, a storage section 606, an image processing section 607, a print processing section 608, a scan processing section 609, a cloud scanning control section 610, a cloud scanning job information management section 611, a cloud scanning device information management section 612, and a WebUI control section 613.

The operation control section 600 controls the operation panel 511. An operation menu is displayed on the operation panel 511 to wait for an instruction input from the user, the received instruction content is notified to another functional unit, and an instruction result is displayed on the operation panel 511.

The cloud device registration control section 601 controls processing of registering the multi function peripheral 101 into the cloud device registration service 102 in response to the request 110 for cloud device registration received from the client terminal 100.

The WebUI control section 613 controls display and input of Web content for receiving the operation of the multi function peripheral 101 via the Web. As an example, in the present example, the multi function peripheral 101 receives the request 110 for cloud device registration via the web.

The cloud printing print control section 602 transfers, to the image processing section 607, the job data 326 received from the cloud printing service 200 together with a print instruction in accordance with the job attribute 325.

The image processing section 607 performs processing of rendering a print job into image data for printing.

The print processing section 608 performs processing of printing the image data rendered by the image processing section 607.

The cloud printing job information management section 603 manages, and notifies the cloud printing service 200 of, the job information of the multi function peripheral 101.

The cloud printing event control section 604 controls event notification processing between the multi function peripheral 101 and the cloud printing event notification service 201.

The cloud printing device information management section 605 manages, and notifies the cloud printing service 200 of, print device information of the multi function peripheral 101.

The scan processing section 609 controls processing of scanning a document set in the scanner of the multi function peripheral 101 and fetching the document as data.

The cloud scanning control section 610 controls processing of executing scanning and transmitting generated data to the cloud scanning service 1100 in accordance with an instruction from the client terminal 100. The cloud scanning control section 610 transfers, to the image processing section 607, the job data 326 received from the cloud scanning service 1100 together with a print instruction in accordance with the job attribute 325.

The cloud scanning job information management section 611 manages cloud job information in the multi function peripheral 101 and the cloud scanning service 1100, and notifies job information in response to an inquiry from the client terminal 100.

The cloud scanning device information management section 612 manages the scan device information of the multi function peripheral 101 and notifies the client terminal 100 and the cloud scanning service 1100 of the scan device information.

The storage section 606 stores designated data into the HDD 505 or the RAM 503 in accordance with an instruction from another functional unit. The storage section 606 reads data stored in the RAM 503, the ROM 504, and the HDD 505. Examples of data managed by the storage section 606 include print job data and scan job data.

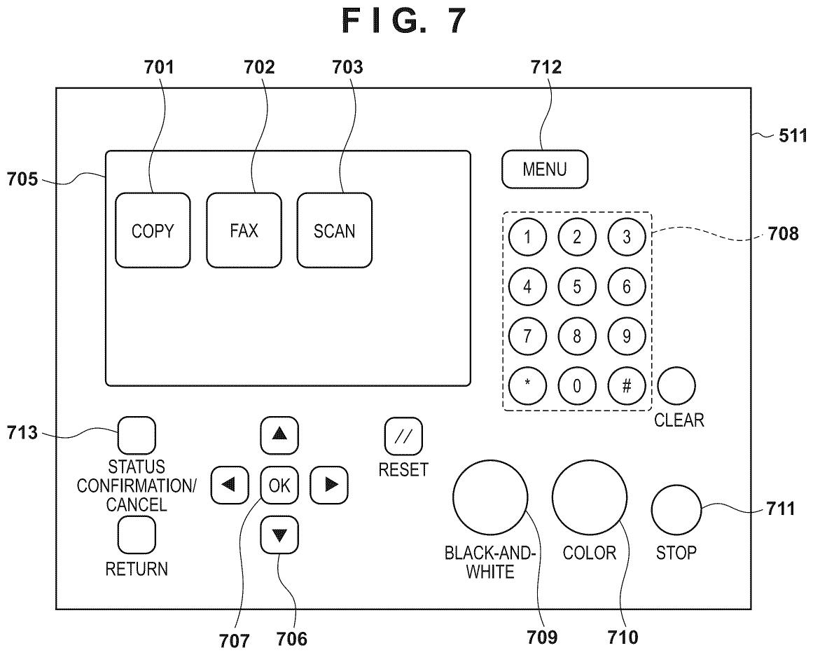

The operation panel 511 of the multi function peripheral 101 will be described with reference to FIG. 7. The operation panel 511 includes a display panel 705, direction keys 706, an OK key 707, a numeric keypad 708, a black-and-white button 709, a color button 710, a stop button 711, a menu button 712, and a status confirmation/cancel button 713. The display panel 705 is a display panel using an LCD or the like. The display panel 705 displays a copy button 701, a FAX button 702, and a scan button 703.

The copy button 701 is a button operated when copying is performed using the multi function peripheral 101, and a copy operation screen is displayed on the display panel 705 by operating the copy button 701. The FAX button 702 is a button operated when FAX is performed using the multi function peripheral 101, and a FAX operation screen is displayed on the display panel 705 by operating the FAX button 702. The scan button 703 is a button operated when scanning is performed using the multi function peripheral 101, and a scan operation screen is displayed on the display panel 705 by operating the scan button 703. The display panel 705 displays also a dialog for exchanging with the user. Furthermore, in the present example, a login screen of the user and a print job list display screen are displayed.

The numeric keypad 708 is used for inputting numbers and the like. The OK key 707 is used when display content of the display panel 705 is decided. The direction keys 706 are used when a menu or the like displayed on the display panel 705 is selected. The black-and-white button 709 and the color button 710 are used when black-and-white copy and color copy, respectively, are performed. The stop button 711 is used when the processing is stopped. The menu button 712 is used when a menu screen for setting the multi function peripheral 101 is displayed. The status confirmation/cancel button 713 is used when the status of the multi function peripheral 101 such as a list of print jobs being received by the multi function peripheral 101 is confirmed.

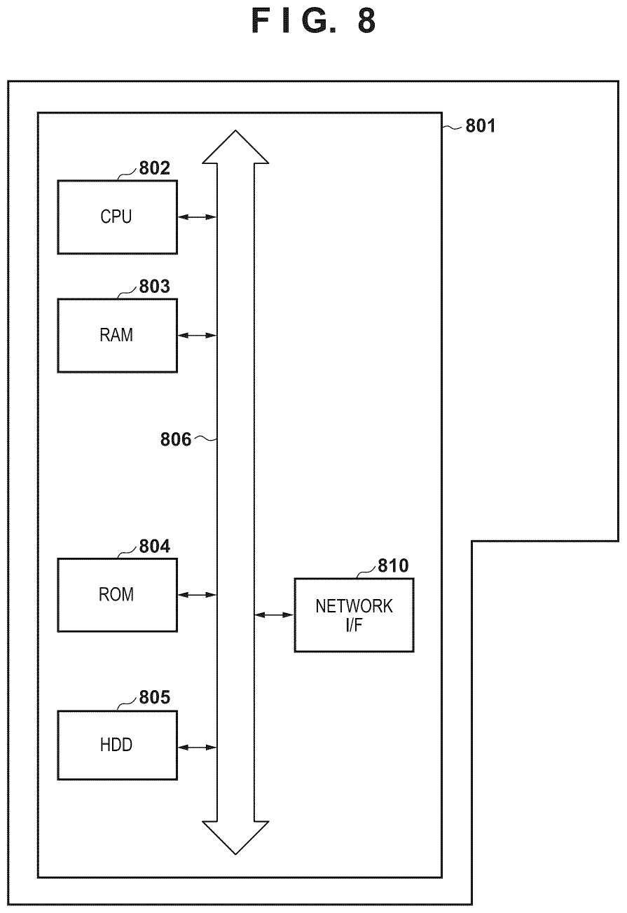

The hardware configuration of the cloud print server according to the present invention will be described with reference to FIG. 8. The cloud print server is a server that handles the cloud device registration service 102, the cloud printing service 200, the cloud scanning services 1100, and the cloud printing event notification service 201. The cloud print server includes a control unit 801, and the control unit 801 includes a CPU 802, a RAM 803, a ROM 804, an HDD 805, a system bus 806, and a network I/F 810. The blocks in the control unit 801 are connected by the system bus 806.

The control unit 801 including the CPU 802 controls the operation of the entire service handled by the cloud print server. The CPU 802 performs various types of control such as communication control by reading, into the RAM 803, control programs stored in the ROM 804 and executing the control programs. The RAM 803 is used as a temporary storage area such as a main memory and a work area of the CPU 802. The HDD 805 stores data, various programs, or various information tables. The network I/F 810 transmits information to external terminals such as the client terminal 100 and the multi function peripheral 101, or receives various types of information from the external devices.

Note that the cloud device registration service 102, the cloud printing service 200, the cloud scanning service 1100, and the cloud printing event notification service 201 may be services realized by different servers. One service may be realized by a plurality of servers. The cloud print server may be one or a plurality of cloud print servers, and when the cloud print server is called a server system, the cloud print server refers to a device that handles each service including one or a plurality of cloud print servers.

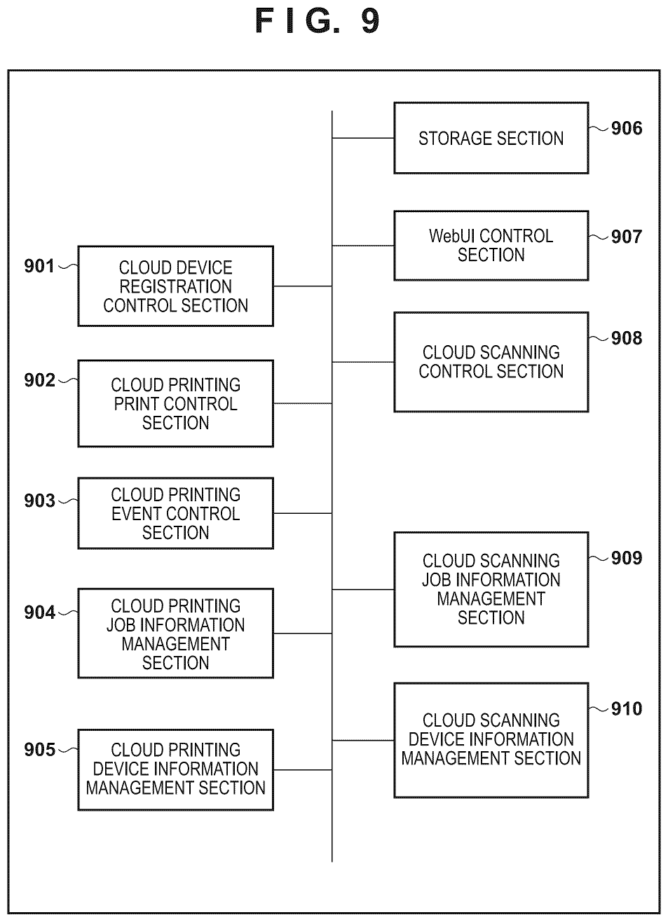

The software configuration of the cloud print server according to the present invention will be described with reference to FIG. 9. The cloud device registration service 102, the cloud printing service 200, the cloud scanning service 1100, and the cloud printing event notification service 201 of the present invention are realized by software of the cloud print server.

The software of the cloud print server includes a cloud device registration control section 901, a cloud printing print control section 902, a cloud printing event control section 903, a cloud printing job information management section 904, a cloud printing device information management section 905, a storage section 906, a WebUI control section 907, a cloud scanning control section 908, a cloud scanning job information management section 909, and a cloud scanning device information management section 910. Each functional unit illustrated in FIG. 9 is realized by the CPU 802 of the cloud print server reading control programs stored in the ROM 804 into the RAM 803 and executing the control programs.

The cloud print server is connected to the multi function peripheral 101 via a network to constitute a cloud print system.

The cloud device registration control section 901 controls processing of registering the multi function peripheral 101 in the cloud device registration service 102.

The cloud printing print control section 902 controls processing of receiving the print request 302 from the client terminal 100, and transmitting, to the multi function peripheral 101, the print data 322 included in the print request 302.

In response to the event notification registration request 212 and the event acquisition request 213 from the multi function peripheral 101, the cloud printing event control section 903 controls the processing of transmitting the event response 303 in response to the presence or absence of an event.

The cloud printing job information management section 904 manages information and the status of the print job.

The cloud printing device management section 905 manages a plurality of multi function peripherals 101 registered in the cloud device registration service 102. Specifically, print capability information of a multi function peripheral corresponding to each multi function peripheral 101 and information of a print queue in which the print job is spooled are stored and managed.

The storage section 906 stores designated data into the HDD 805 or the RAM 803 in accordance with an instruction from another functional unit. The storage section 906 reads data stored in the RAM 803, the ROM 804, and the HDD 805. Examples of data managed by the storage section 906 include the print data 322, event information, and capability information of the registered multi function peripheral 101.

The cloud scanning control section 908 controls processing of receiving a scan job transmitted from the multi function peripheral 101 and transmitting the scan job to the scan data transmission destination 400.

The cloud scanning job information management section 909 manages information and the status of the scan job.

The cloud scanning device management section 910 manages the plurality of multi function peripherals 101 registered in the cloud device registration service 102. Specifically, scanning capability information of a multi function peripheral corresponding to each multi function peripheral 101 is stored and managed.

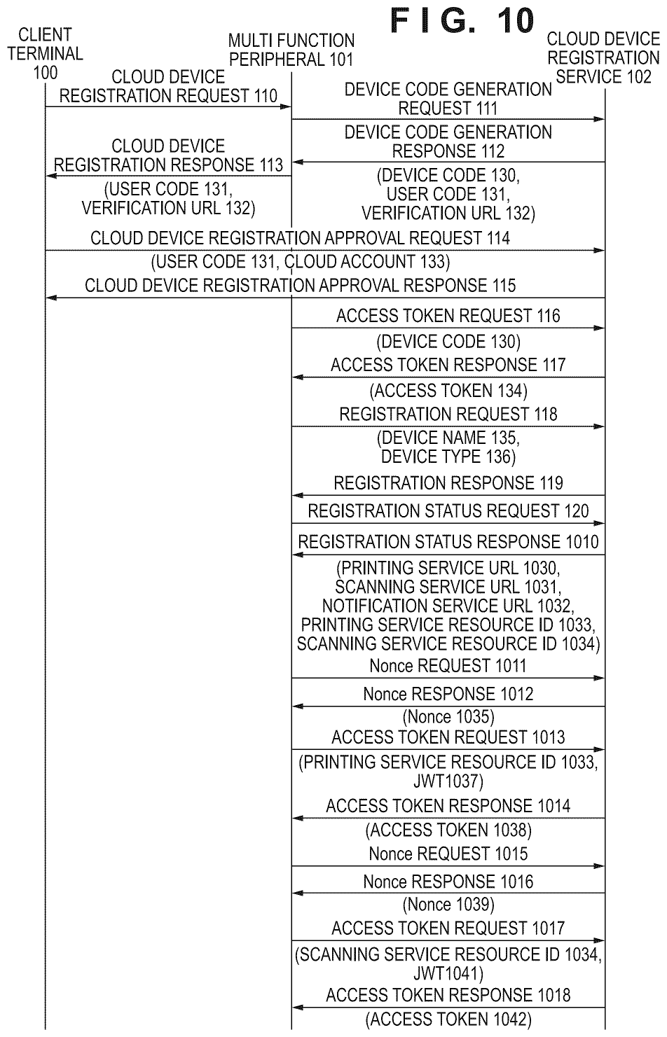

A cloud device registration sequence of the multi function peripheral in the present example will be described with reference to FIG. 10.

The sequence of the first half until the multi function peripheral 101 of the present sequence receives the access token response 117 is exactly the same as the cloud printing registration sequence diagram of the multi function peripheral described in FIG. 1. Therefore, description up to the access token response 117 will be omitted here, and description will be made starting from a part where the multi function peripheral 101 transmits the registration request 118.

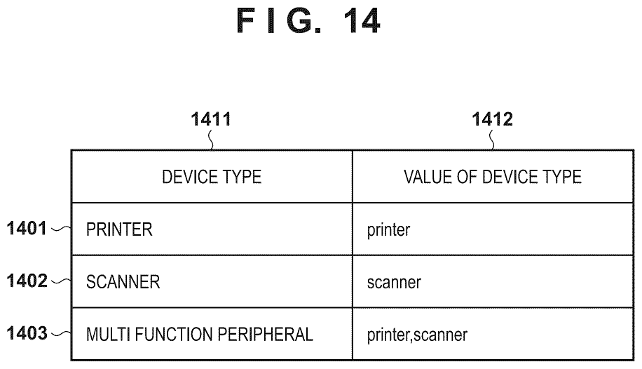

The multi function peripheral 101 transmits the registration request 118 to the cloud device registration service 102. The registration request 118 includes the device name 135 and the device type 136. The access token 134 is added to the HTTP header of the registration request 118. The device name 135 is a device name set in the multi function peripheral 101. The device type 136 represents a device type of the multi function peripheral 101. As shown in FIG. 14, a value of the device type determined by whether the device is a printer, a scanner, or a multi function peripheral is set. In the present example, since the device is a multi function peripheral, “printer, scanner” is set. FIG. 14 will be described later.

The device type 136 to be set here is determined based on whether or not the multi function peripheral 101 has each function regardless of whether each setting of the cloud printing setting and the cloud scanning setting of the multi function peripheral 101 is currently enabled or disabled.

A cloud device registration sequence of the multi function peripheral in the present example will be described with reference to FIG. 10.

The sequence of the first half until the multi function peripheral 101 of the present sequence receives the access token response 117 is exactly the same as the cloud printing registration sequence diagram of the multi function peripheral described in FIG. 1. Therefore, description up to the access token response 117 will be omitted here, and description will be made starting from a part where the multi function peripheral 101 transmits the registration request 118.

The multi function peripheral 101 transmits the registration request 118 to the cloud device registration service 102. The registration request 118 includes the device name 135 and the device type 136. The access token 134 is added to the HTTP header of the registration request 118. The device name 135 is a device name set in the multi function peripheral 101. The device type 136 represents a device type of the multi function peripheral 101. As shown in FIG. 14, a value of the device type determined by whether the device is a printer, a scanner, or a multi function peripheral is set. In the present example, since the device is a multi function peripheral, “printer, scanner” is set. FIG. 14 will be described later.

Upon receiving the registration request 118, the cloud device registration service 102 determines whether or not the access token 134 is a token to which the cloud device registration service 102 itself has responded with the access token response 117. This confirms whether the transmitted registration request is an authorized registration request. Upon determining that the registration request 118 is an authorized registration request as a result of the confirmation, the cloud device registration service 102 transmits the registration response 119 to the multi function peripheral 101 and starts registration processing of the multi function peripheral 101.

The multi function peripheral 101 transmits the registration status request 120 to the cloud device registration service 102. Also in the registration status request 120, the access token 134 is added to the HTTP header.

Upon receiving the registration status request 120, the cloud device registration service 102 confirms the access token 134 in the same manner as when receiving the registration request 118, and upon determining that the registration status request 120 is an authorized registration status request, the cloud device registration service continues the following processing. When the registration is completed, the cloud device registration service 102 transmits a registration status response 1010 to the multi function peripheral 101. The registration status response 1010 includes a printing service URL 1030, a scanning service URL 1031, a notification service URL 1032, a printing service resource ID 1033, and a scanning service resource ID 1034. The printing service URL 1030 is information indicating an end point of the cloud printing service. The scanning service URL 1031 is information indicating an end point of the cloud scanning service 1100. The notification service URL 1032 is information indicating an end point of the cloud printing event notification service. The printing service resource ID 1033 is unique information generated by the cloud device registration service for acquiring an access token for using the printing service. The scanning service resource ID 1034 is unique information generated by the cloud device registration service for acquiring an access token for using the scanning service. The printing service resource ID 1033 and the scanning service resource ID 1034 are examples of service identifiers for acquiring an access token in the present invention.

Next, in a sequence from a Nonce request 1011 to an access token response 1014, the multi function peripheral 101 acquires an access token for using the cloud printing service. The access token acquisition processing for using the cloud printing service described here is performed only when the cloud printing setting of the multi function peripheral 101 is enabled.

The multi function peripheral 101 transmits a Nonce request 1011 to the cloud device registration service 102. Upon receiving the Nonce request 1011, the cloud device registration service 102 generates a Nonce 1035 and transmits a Nonce response 1012 to the multi function peripheral 101. The Nonce response 1012 includes the Nonce 1035.

Upon acquiring the Nonce 1035 by the Nonce response 1012, the multi function peripheral 101 generates a JWT 1037. Then, the multi function peripheral 101 transmits an access token request 1013 to the cloud device registration service 102. The access token request 1013 includes the printing service resource ID 1033 received from the cloud device registration service 102 and the JWT 1037 generated by the multi function peripheral 101.

Upon receiving the access token request 1013, the cloud print server verifies the Nonce 1035 that is generated and the JWT 1037 received from the multi function peripheral 101 to authenticate the multi function peripheral 101. Based on the printing service resource ID 1033 included in the access token request 1013, the cloud device registration service 102 generates an access token 1038, and transmits an access token response 1014 to the multi function peripheral 101. The access token response 1014 includes the access token 1038.

The access token 1038 acquired here is used when the multi function peripheral 101 communicates with the cloud printing service 200.

Next, in a sequence from a Nonce request 1015 to an access token response 1018, the multi function peripheral 101 acquires an access token for the cloud scanning service 1100. The access token acquisition processing for using the cloud scanning services described here is performed only when the cloud scanning setting of the multi function peripheral 101 is enabled.

The multi function peripheral 101 transmits a Nonce request 1015 to the cloud device registration service 102. Upon receiving the Nonce request 1015, the cloud device registration service 102 generates a Nonce 1039 and transmits a Nonce response 1016 to the multi function peripheral 101. The Nonce response 1016 includes the Nonce 1039.

Upon acquiring the Nonce 1039 by the Nonce response 1016, the multi function peripheral 101 generates a JWT 1041. Then, the multi function peripheral 101 transmits an access token request 1017 to the cloud device registration service 102. The access token request 1017 includes the scanning service resource ID 1034 received from the cloud device registration service 102 and the JWT 1041 generated by the multi function peripheral 101.

Upon receiving the access token request 1017, the cloud print server verifies the Nonce 1039 that is generated and the JWT 1041 received from the multi function peripheral 101 to authenticate the multi function peripheral 101. Based on the scanning service resource ID 1034 included in the access token request 1039, the cloud device registration service 102 generates an access token 1042, and transmits an access token response 1018 to the multi function peripheral 101. The access token response 1018 includes the access token 1042.

The access token 1042 acquired here is used when the multi function peripheral 101 communicates with the cloud scanning service 1100.

Note that the present example is described on an assumption that the cloud printing service 200 and the cloud scanning service 1100 use access tokens different from each other. Therefore, the Nonce request and the access token request are performed twice. An embodiment in which the same access token is used in the cloud printing service 200 and the cloud scanning service 1100 may be adopted. In that case, the Nonce request and the access token request are performed only once.

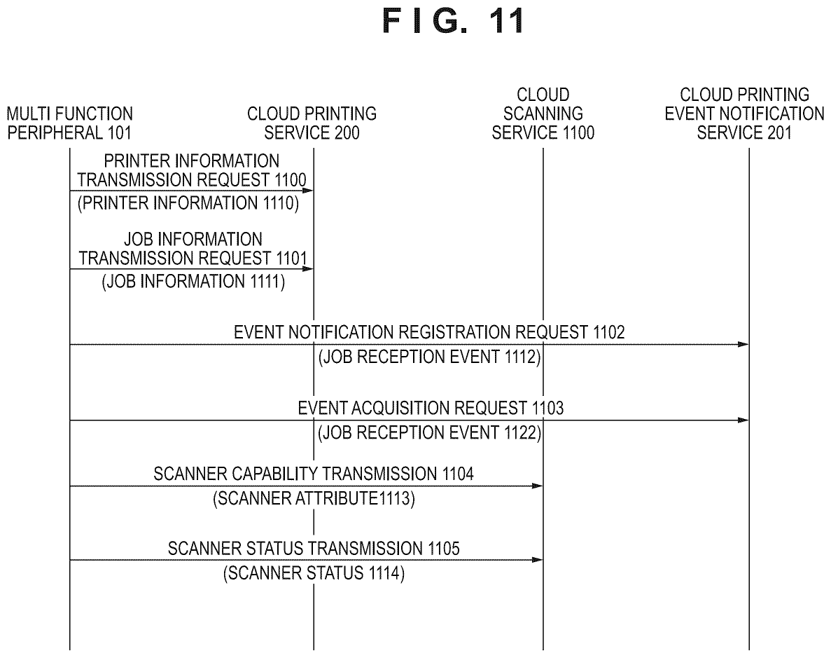

The startup sequence of the multi function peripheral in the present example will be described with reference to FIG. 11.

A description will be given on an assumption that in the present sequence, the multi function peripheral 101 communicates with the cloud printing service 200 and the cloud printing event notification service 201 using IPP, which is a printing protocol using HTTP. In the HTTP communication by IPP, the multi function peripheral 101 sets the access token 1038 for the printing service in the HTTP header. Due to this, the cloud printing service 200 and the cloud printing event notification service 201 authorize the request.

A description will be given on an assumption that communication between the multi function peripheral 101 and the cloud scanning service 1100 uses eSCL, which is a scanning protocol using HTTP. In the HTTP communication by eSCL, the multi function peripheral 101 sets the access token 1042 for the scanning service in the HTTP header. Due to this, the cloud scanning service 1100 authorizes the request.

In the present sequence, communication between the multi function peripheral 101 and the cloud printing service 200 and communication between the multi function peripheral 101 and the cloud printing event notification service 201 are executed when the cloud printing setting of the multi function peripheral 101 is enabled.

In the present sequence, communication between the multi function peripheral 101 and the cloud scanning service 1100 is executed when the cloud scanning setting of the multi function peripheral 101 is enabled.

The multi function peripheral 101 transmits a job information transmission request 1101 to the cloud printing service 200. The IPP operation is Update-Active-Jobs. The job information transmission request 1101 includes job information 1111. The job information 1111 includes job-ids and output-device-job-states, which are IPP attributes. job-ids indicates an ID of a job, and output-device-job-states indicates a status of the job.

The multi function peripheral 101 transmits an event notification registration request 1102 to the cloud printing event notification service 201. The IPP operation is Create-Printer-Subscription. The event notification registration request 1102 includes a job reception event 1112 indicating the type of the event to be notified. The job reception event 1112 includes job-fetchable, which is an IPP attribute. job-fetchable is an event type indicating that a receivable job exists in the cloud printing service 200.

The multi function peripheral 101 transmits scanner capability transmission 1104 to the cloud scanning service 1100. The eSCL operation is ScannerCapabilities. The scanner capability transmission 1104 includes a scanner attribute 1113. The scanner attribute 1113 is information representing the capability of the scanner expressed in XML.

The multi function peripheral 101 transmits scanner status transmission 1105 to the cloud scanning service 1100. The eSCL operation is ScannerStatus. The scanner status transmission 1105 includes a scanner status 1114. The scanner status 1114 is information representing the status of the scanner expressed in XML.

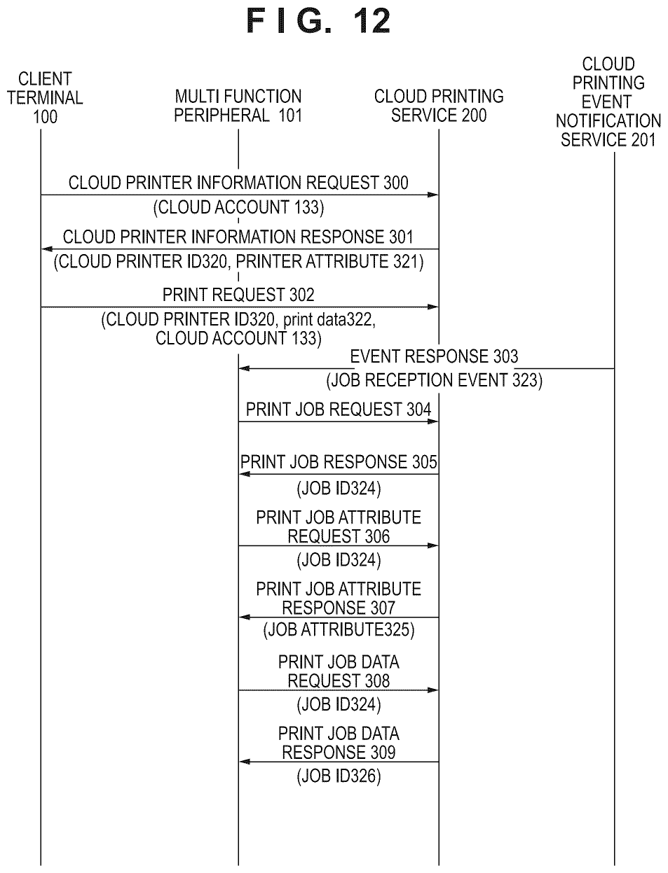

FIG. 12 is a cloud printing print sequence diagram of the multi function peripheral in the present example. The cloud printing print sequence is exactly the same as the sequence of FIG. 3. Therefore, the description will be omitted here. Note that it is assumed that in the present sequence, the multi function peripheral 101 communicates with the cloud printing service 200 and the cloud printing event notification service 201 using IPP, which is a printing protocol using HTTP. In the HTTP communication by IPP, the multi function peripheral 101 sets the access token 1038 for the printing service in the HTTP header. Due to this, the cloud printing service 200 and the cloud printing event notification service 201 authorize the request.

The present sequence is executed when the cloud printing setting of the multi function peripheral 101 is enabled. The client terminal 100 transmits the cloud printer information request 300 to the cloud printing service 200. When the cloud printing setting of the multi function peripheral 101 is disabled, the cloud printing service 200 does not respond to the cloud printer information request 300 with a desired cloud printer ID as the cloud printer information response 301. Due to this, the client terminal 100 does not perform processing of transmitting the print request 302 to the cloud printing service 200, and the print sequence is not executed.

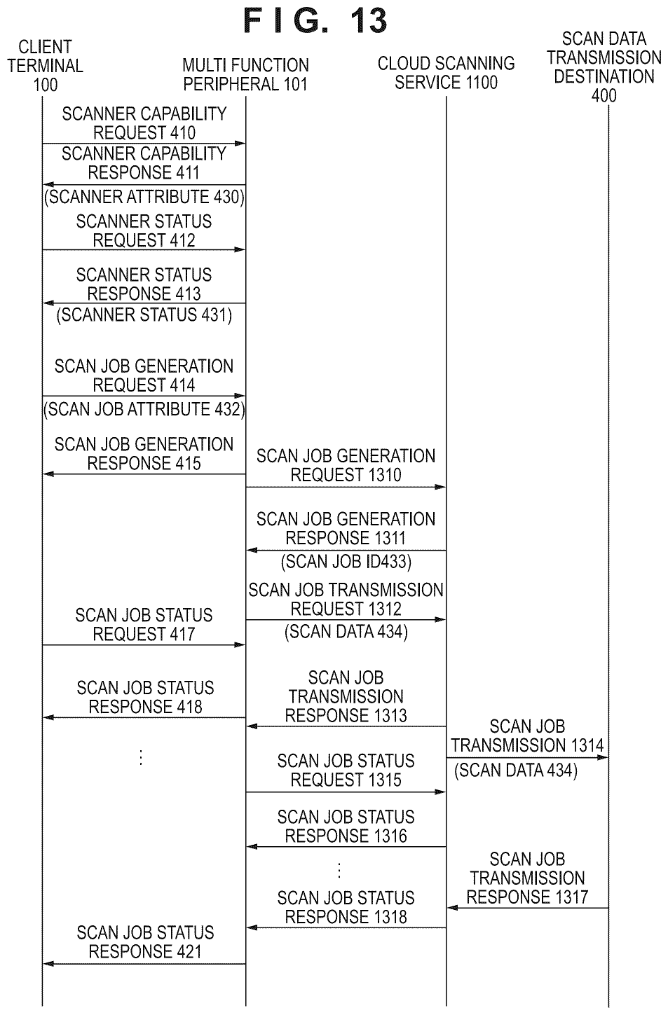

With reference to FIG. 13, the scan sequence of cloud scanning of the multi function peripheral in the present example will be described. A description will be given on an assumption that in the present sequence, communication between the multi function peripheral 101 and the cloud scanning service 1100 uses eSCL, which is a scanning protocol using HTTP. In the HTTP communication by eSCL, the multi function peripheral 101 sets the access token 1042 for the scanning service in the HTTP header. Due to this, the cloud scanning service 1100 authorizes the request.

The sequence of the first half until the multi function peripheral 101 of the present sequence transmits the scan job generation response 415 is exactly the same as the scan sequence diagram of the local scanning functions of the multi function peripheral described in FIG. 4. Therefore, description up to the scan job generation response 415 will be omitted here, and description will be made starting from a part where the multi function peripheral 101 transmits a scan job generation request 1310.

The present sequence is executed when the cloud scanning setting of the multi function peripheral 101 is enabled. The client terminal 100 transmits the scanner capability request 410 to the multi function peripheral 101. When the cloud scanning setting is disabled, the multi function peripheral 101 does not respond with the scanner capability response 411 even when receiving the scanner capability request 410. Alternatively, the multi function peripheral 101 responds with the scanner capability response 411, but responds with the scanner capability response 411 with the cloud scanning capability among the capability attribute therein as disabled. Due to this, the client terminal 100 does not perform processing of transmitting the scan job generation request 414 to the multi function peripheral 101, and the scan sequence is not executed.

The multi function peripheral 101 transmits the scan job generation request 1310 to the cloud scanning service 1100. The eSCL operation is ScanJobs. The scan job generation request 1310 may include the scan job attribute 432 transmitted from the client terminal 100.

Upon receiving the scan job generation request 1310, the cloud scanning service 1100 generates a scan job and transmits a scan job generation response 1311 to the multi function peripheral 101. The eSCL operation is ScanJobs Response. The scan job generation response 1311 includes a scan job ID 433.

The multi function peripheral 101 transmits a scan job transmission request 1312 to the cloud scanning service 1100. The eSCL operation is ScanJobs. The scan job transmission request 1312 includes scan data 434.

Upon receiving the scan job transmission request 1312, the cloud scanning service 1100 saves the scan data into the storage area and transmits a scan job transmission response 1313 to the multi function peripheral 101. The eSCL operation is ScanJobs Response.

The cloud scanning service 1100 transmits a scan job transmission 1314 to the scan data transmission destination 400. The scan job transmission 1314 includes the scan data 434. Note that a protocol determined between the scan job transmission 1314 and the scan data transmission destination 400 is used for the scan job transmission 1314. The eSCL is not necessarily used.

Upon receiving the scan job transmission 1314, the scan data transmission destination 400 transmits a scan job transmission response 1317 to the cloud scanning service 1100. Note that a protocol determined between the scan job transmission response 1317 and the scan data transmission destination 400 is used for the scan job transmission response 1317. The eSCL is not necessarily used.

The multi function peripheral 101 transmits a scan job status request 1315 to the cloud scanning service 1100 in order to confirm the status of the scan job. The eSCL operation is ScannerStatus.

Upon receiving the scan job status request 1315, the cloud scanning service 1100 transmits a scan job status response 1316 to the multi function peripheral 101. The eSCL operation is ScannerStatus Response.

The scan job status response 1316 is repeated until the scan job transitions to the final status.

The client terminal 100 transmits the scan job status request 417 to the multi function peripheral 101 in order to confirm the status of the scan job. The eSCL operation is ScannerStatus.

Upon receiving the scan job status request 417, the multi function peripheral 101 transmits a scan job status response 418 to the client terminal 100. The eSCL operation is ScannerStatus Response.

The scan job status response 418 is repeated until the scan job transitions to the final status.

With reference to FIG. 14, the device type that the multi function peripheral in the present example transmits at the time of cloud device registration will be described. The device type described here is one that the multi function peripheral 101 sets for the registration request 118 in the cloud device registration sequence diagram described in FIG. 10.

Examples of a device type 1411 include a printer, a scanner, and a multi function peripheral. The multi function peripheral 101 selects a device type depending on a service to be registered in the cloud device registration service.

In the case of registering as a printer having cloud printing functions, “printer” is set as the value of the device type. In the case of registering as a scanner having cloud scanning functions, “scanner” is set as the value of the device type. In the case of registering as a multi function peripheral having both cloud printing functions and cloud scanning functions, “printer, scanner” is set as the value of the device type.

In the case of the multi function peripheral, the value of the device type may be set to “MFP”. In that case, the cloud device registration service 102 controls the registered device on an assumption of having the cloud printing service 200 and the cloud scanning service 1100.

The device type is determined based on whether or not the multi function peripheral 101 has each function as a device regardless of whether each setting of the cloud printing setting and the cloud scanning setting of the multi function peripheral 101 is currently enabled or disabled.

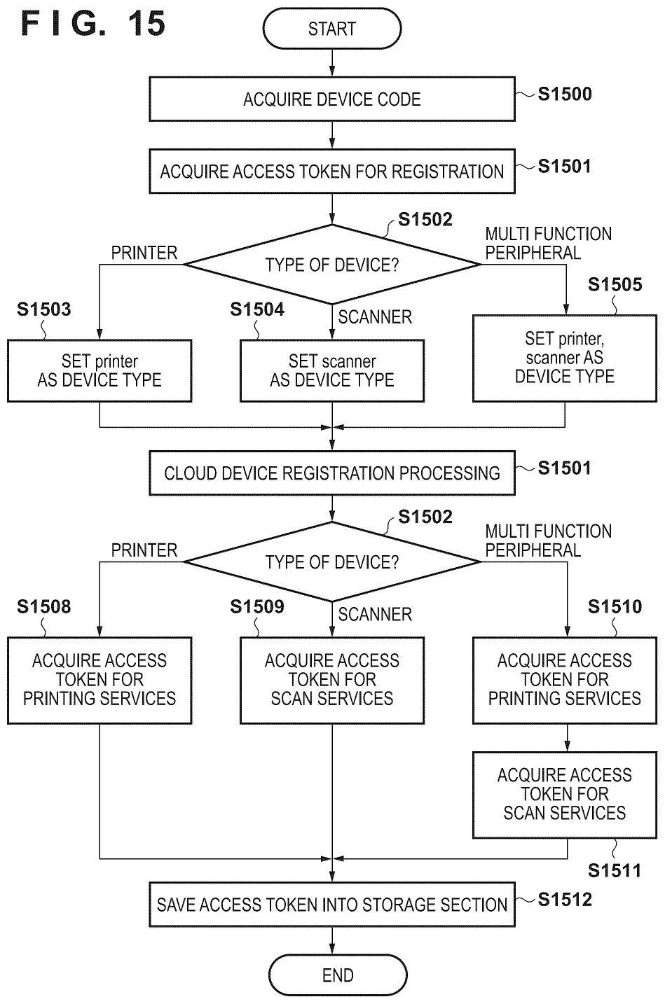

The flow of the cloud device registration processing of the multi function peripheral in the present example will be described with reference to FIG. 15. The processing described below is realized, for example, by the CPU 502 of the multi function peripheral 101 reading, into the RAM 503, a program stored in the ROM 504 and executing the program. Hereinafter, the step number of each process included in the flowchart is indicated by a number starting with “S”. The same applies to the subsequent flowcharts.

The present flowchart is started by the multi function peripheral 101 receiving the request 110 for cloud device registration described in FIG. 10 from the client terminal 100.

In S1500, the cloud device registration control section 601 of the multi function peripheral 101 acquires a device code. This is processing realized by the device code generation request 111 and the device code generation response 112 of FIG. 10.

In S1501, the cloud device registration control section 601 of the multi function peripheral 101 acquires an access token for registration. This is processing realized by the access token request 116 and the access token response 117 of FIG. 10.

In S1502, the cloud device registration control section 601 of the multi function peripheral 101 determines the type of the device. If the device type is a printer, the process proceeds to S1503, “printer” is set as the device type, and the process proceeds to S1506. If the device type is a scanner, the process proceeds to S1504, “scanner” is set as the device type, and the process proceeds to S1506. If the device type is a multi function peripheral, the process proceeds to S1505, “printer, scanner” is set as the device type, and the process proceeds to S1506.

In S1506, the cloud device registration control section 601 of the multi function peripheral 101 performs cloud device registration processing. This is processing realized by the registration request 118, the registration response 119, the registration status request 120, and the registration status response 1010 of FIG. 10. The information transmitted in the registration request 118 also includes the device type generated in S1503, S1504, or S1505.

When the cloud device registration processing of S1506 is completed, the cloud device registration control section 601 of the multi function peripheral 101 proceeds to S1507 and performs access token acquisition processing. First, in S1507, the type of the device is determined. If the type of the device is a printer, the process proceeds to S1508 to acquire an access token for printing services. If the type of the device is a scanner, the process proceeds to S1509 to acquire an access token for scanning services.

If the type of the device is a multi function peripheral, the process proceeds to S1510, and to acquire first an access token for printing services, and the process proceeds to S1511. In S1511, an access token for scanning services is acquired.

When the cloud device registration control section of the multi function peripheral 101 acquires the access token in S1508 to 1511, the process proceeds to S1512. In S1512, the cloud device registration control section 601 of the multi function peripheral 101 saves the acquired access token into the storage section 606.

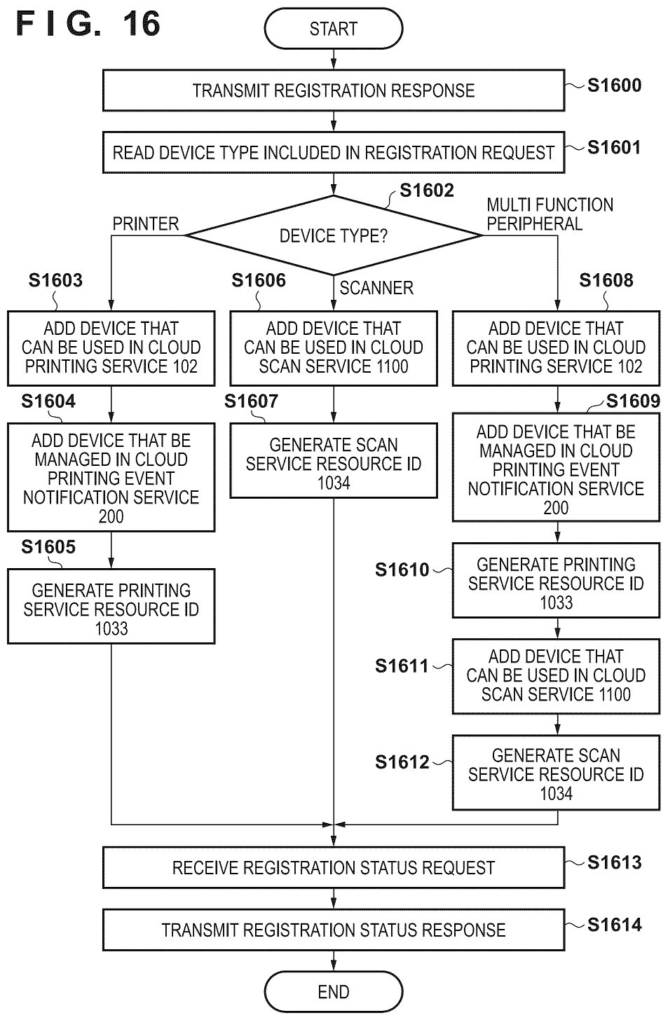

The flow of processing when the cloud device registration service 102 of the cloud print server in the present example receives a registration request will be described with reference to FIG. 16. The processing described below is realized, for example, by the CPU 802 of the cloud print server reading, into the RAM 803, a program stored in the ROM 804 and executing the program.

The present flowchart is started when the cloud device registration service 102 receives the registration request 118 described with reference to FIG. 10 from the multi function peripheral 101.

In S1600, the cloud device registration control section 901 of the cloud device registration service 102 analyzes the message of the registration request 118 and transmits the registration response 119 indicating registration reception, and the process proceeds to S1601.

In S1601, the cloud device registration control section 901 of the cloud device registration service 102 reads the device type included in the message of the registration request 118, and the process proceeds to S1602.

In S1602, the cloud device registration control section 901 of the cloud device registration service 102 determines the value set to the device type read in S1601.

If the value of the device type indicates the printer in S1602, the process proceeds to S1603. In S1603, the cloud printing device information management section 905 of the cloud device registration service 102 adds the device for which a registration request has been made as a device that can be used in the cloud printing service 200, and the process proceeds to S1604.

In S1604, the cloud printing event control section 903 of the cloud device registration service 102 adds the device for which the registration request has been made as the device that performs event notification in the cloud printing event notification service 201, and the process proceeds to S1605.

In S1605, the cloud printing registration control section 903 of the cloud device registration service 102 generates the printing service resource ID 1033, and the process proceeds to S1613.

If the value of the device type indicates the scanner in S1602, the process proceeds to S1606. In S1606, the cloud printing device information management section 905 of the cloud device registration service 102 adds the device for which a registration request has been made as a device that can be used in the cloud scanning service 1100, and the process proceeds to S1607.

In S1607, the cloud printing registration control section 903 of the cloud device registration service 102 generates the scanning service resource ID 1034, and the process proceeds to S1613.

If the value of the device type indicates the multi function peripheral in S1602, the process proceeds to S1608. In S1608, the cloud printing device information management section 905 of the cloud device registration service 102 adds the device for which a registration request has been made as a device that can be used in the cloud printing service 200, and the process proceeds to S1609.

In S1609, the cloud printing event control section 903 of the cloud device registration service 102 adds the device for which the registration request has been made as the device that performs event notification in the cloud printing event notification service 201, and the process proceeds to S1610.

In S1610, the cloud printing registration control section 903 of the cloud device registration service 102 generates the printing service resource ID 1033, and the process proceeds to S1611.

In S1611, the cloud printing device information management section 905 of the cloud device registration service 102 adds the device for which a registration request has been made as a device that can be used in the cloud scanning service 1100, and the process proceeds to S1612.

In S1612, the cloud printing registration control section 903 of the cloud device registration service 102 generates the scanning service resource ID 1034, and the process proceeds to S1613.

In S1613, the cloud device registration control section 901 of the cloud device registration service 102 receives the registration status request 120 from the multi function peripheral 101, and the process proceeds to S1614.

In S1614, the cloud device registration control section 901 of the cloud device registration service 102 transmits the registration status response 1010 to the multi function peripheral 101. The following data is set in the registration status response 1010 depending on the device type.

If the device type is the printer, the printing service URL 1030, the notification service URL 1032, and the printing service resource ID 1033 are set.

If the device type is the scanner, the scanning service URL 1031 and the scanning service resource ID 1034 are set.

When the device type is the multi function peripheral, the printing service URL 1030, the scanning service URL 1031, the notification service URL 1032, the printing service resource ID 1033, and the scanning service resource ID 1034 are set.

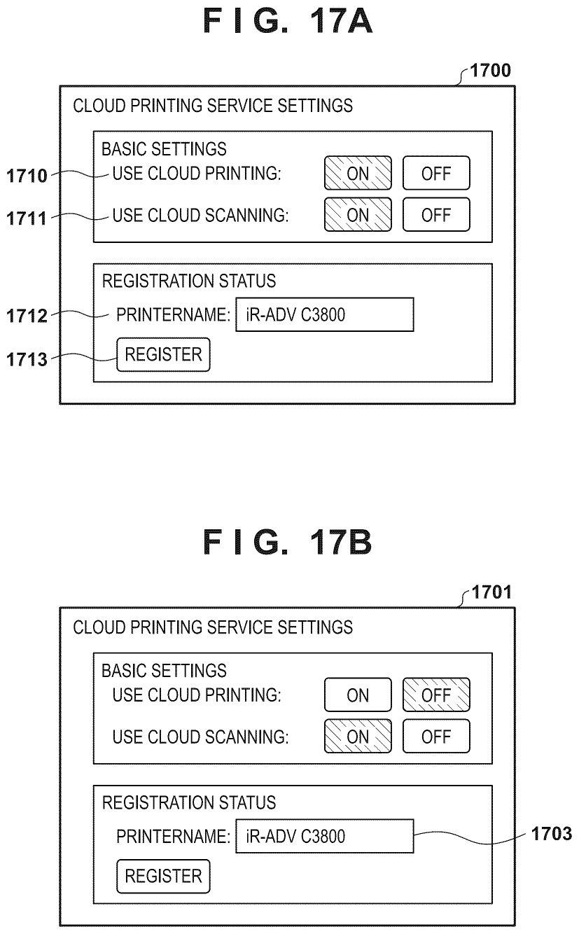

Setting in the UI of the multi function peripheral in the present example will be described with reference to FIG. 17.

The present UI may be a setting screen displayed on the display panel 705 of the operation panel 511 of the multi function peripheral 101, or may be a setting screen displayed on a browser of the client terminal 100. In the latter case, the setting screen to be displayed is generated by the Web UI control section 613 of the multi function peripheral 101 and is displayed by being further transmitted to the client terminal 100. In this case, setting of enabling/disabling of use of the cloud printing service 200 and the cloud scanning service 1100 is performed from the client terminal 100.

A use setting 1710 of the cloud printing is a setting indicating whether the cloud printing setting is enabled or disabled. When the use setting 1710 of the cloud printing is ON, the multi function peripheral 101 transmits information of the multi function peripheral 101 to the cloud printing service 200 and the cloud printing event notification service in the startup sequence described with reference to FIG. 11. This brings the cloud printing service 200 into an available state.

A use setting 1711 of the cloud scanning is a setting indicating whether the cloud scanning setting is enabled or disabled. When the use setting 1711 of the cloud scanning is ON, the multi function peripheral 101 transmits information of the multi function peripheral 101 to the cloud scanning service 1100 in the startup sequence described with reference to FIG. 11. This brings the cloud scanning service into an available state.

A printer name 1712 is used as a value to be set in the device name 135 in the registration request 118.

A registration button 1713 is a button used for registering the multi function peripheral 101 to the cloud device registration service 102. When the registration button 1713 is operated, the cloud device registration sequence described with reference to FIG. 10 is started.

A screen 1700 of FIG. 17A indicates a setting in which both cloud printing and cloud scanning are enabled.

A screen 1701 of FIG. 17B indicates a setting in which cloud printing is disabled and cloud scanning is enabled.

A screen 1702 of FIG. 17C indicates a setting in which cloud printing is enabled and cloud scanning is disabled.

A screen 1703 of FIG. 17D indicates a setting in which both cloud printing and cloud scanning are disabled. On the screen 1703, the registration button 1713 is grayed out and brought into an inoperable state.

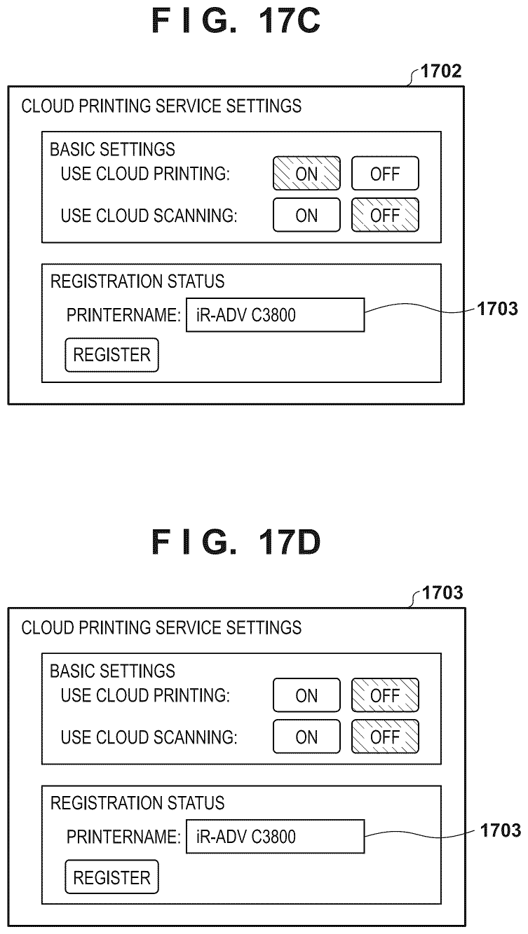

Processing when the cloud printing settings of the multi function peripheral in the present example are changed will be described with reference to FIG. 18. The processing described below is realized, for example, by the CPU 502 of the multi function peripheral 101 reading a program stored in the ROM 504 or the HDD 514 into the RAM 503 and executing the program.

The flowchart of FIG. 18 is started when the use setting 1710 of the cloud printing is changed in FIG. 17.

In S1801, the cloud printing device information management section 605 of the multi function peripheral 101 reads the cloud printing setting from the storage section 606, and the process proceeds to S1802.

In S1802, the cloud printing device information management section 605 of the multi function peripheral 101 determines a setting value for cloud printing.

When the setting value for cloud printing is ON, the process proceeds to S1808, and the cloud device registration control section 601 of the multi function peripheral 101 acquires an access token for the cloud printing services. The access token for the cloud printing services acquired here is used in communication with the cloud print server in S1803 to S1805.

Next, in S1803, the cloud printing device information management section 605 of the multi function peripheral 101 transmits printer information to the cloud printing service 200.

Next, in S1804, the cloud printing job information management section 603 of the multi function peripheral 101 transmits job information to the cloud printing service 200.

Then, in S1805, the cloud printing event control section 604 of the multi function peripheral 101 transmits event notification registration to the cloud printing event notification service 201.

As a result of the determination in S1802, when the setting value for cloud printing is OFF, the process proceeds to S1806, and the cloud printing event control section 604 of the multi function peripheral 101 deletes the event notification registration. Specifically, connection between the multi function peripheral 101 and the cloud printing event notification service 201 is disconnected. If event notification is realized by polling, the polling processing is stopped.

Next, in S1807, the cloud printing print control section 602 of the multi function peripheral 101 interrupts the cloud printing job being processed.

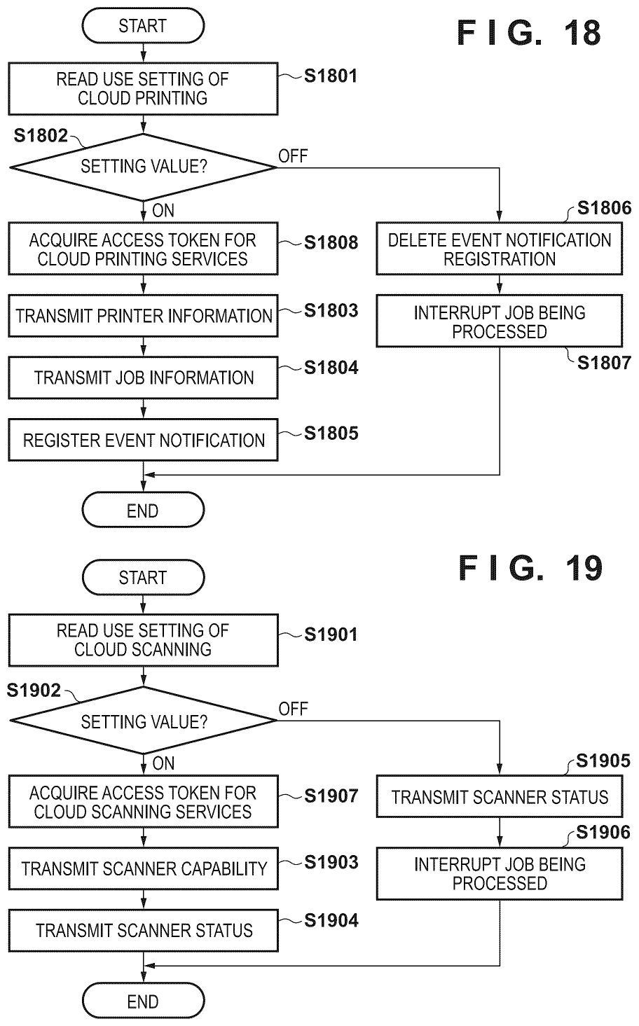

Processing when the cloud scanning settings of the multi function peripheral in the present example are changed will be described with reference to FIG. 19. The processing described below is realized, for example, by the CPU 502 of the multi function peripheral 101 reading a program stored in the ROM 504 or the HDD 514 into the RAM 503 and executing the program.

The flowchart of FIG. 19 is started when the use setting 1711 of the cloud scanning is changed in FIG. 17.

In S1901, the cloud scanning device information management section 612 of the multi function peripheral 101 reads the use setting for cloud scanning from the storage section 606.

In S1902, the cloud scanning device information management section 612 of the multi function peripheral 101 determines a setting value for cloud scanning. As a result of the determination, when the setting value for cloud scanning is ON, the process proceeds to S1907, and the cloud device registration control section 601 of the multi function peripheral 101 acquires an access token for the cloud scanning services. The access token for the cloud scanning services acquired here is used in communication with the cloud print server in S1903 and S1904.

Next, in S1903, the cloud scanning device information management section 612 of the multi function peripheral 101 transmits a scanner capability to the cloud scanning service 1100.

Next, in S1904, the cloud scanning device information management section 612 of the multi function peripheral 101 transmits a scanner status to the cloud scanning service 1100. The scanner status transmitted here is data in which Idle is set to State of ScannerStatus of eSCL.

In S1902, as a result of the determination, when the setting value for cloud scanning is OFF, the process proceeds to S1905, and the cloud scanning device information management section 612 of the multi function peripheral 101 transmits the scanner status to the cloud scanning service 1100. The scanner status transmitted here is data in which Stopped or Down is set to State of ScannerStatus of eSCL.

Next, in S1906, the cloud scanning control section 610 of the multi function peripheral 101 interrupts the scan job being processed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-013309, filed Jan. 31, 2024 which is hereby incorporated by reference herein in its entirety.

What is claimed is:

1. A device that connects, via a network, to a cloud print server system that handles cloud printing services and cloud scanning services, the device comprising:
a transmission unit configured to transmit, to the cloud print server system, a registration request including a device type included in the device among cloud printing functions and cloud scanning functions; and
an acquisition unit configured to acquire, from the cloud print server system, an access token for a service enabled by a setting unit among the cloud printing services and the cloud scanning services.

2. The device according to claim 1, further comprising:
the setting unit, wherein
the setting unit sets enabling/disabling of use of the cloud printing services and enable/disable of use of the cloud scanning services.

3. The device according to claim 1, wherein
when use of the cloud printing services is set to be disabled in a state where the cloud printing functions are registered, registration of event notification of the cloud printing services is deleted, and a cloud printing job being processed is interrupted.

4. The device according to claim 1, wherein
when use of the cloud printing services is set to be enabled in a state where the cloud printing functions are registered, the acquisition unit acquires an access token for cloud printing services from the cloud print server system, and transmits printer information and job information to the cloud print server system by using the access token for cloud printing services, and
registration of event notification of the cloud printing services is performed to the cloud print server system using the access token for cloud printing services.

5. The device according to claim 1, wherein
when use of the cloud scanning services is set to be disabled in a state where the cloud scanning functions are registered, a scanner status is transmitted to the cloud print server system and interrupting a cloud scanning job being processed is interrupted.

6. The device according to claim 1, wherein
when use of the cloud scanning services is set to be enabled in a state where the cloud scanning functions are registered,
the acquisition unit acquires an access token for cloud scanning services from the cloud print server system, and
transmits a scanner capability and a scanner status to the cloud print server system using an access token for the cloud scanning services.

7. The device according to claim 1, wherein
an access token for cloud printing services and an access token for cloud scanning services are different.

8. A method for controlling a device that connects, via a network, to a cloud print server system that handles cloud printing services and cloud scanning services, the method comprising:
transmitting a registration request including a device type included in the device among cloud printing functions and cloud scanning functions to the cloud print server system that handles the cloud printing services and the cloud scanning services; and
acquiring, from the cloud print server system, an access token for a service enabled by a setting unit among the cloud printing services and the cloud scanning services.

9. A non-transitory computer-readable storage medium, the storage medium storing a program for causing a computer to execute each step of controlling a device that connects, via a network, to a cloud print server system that handles cloud printing services and cloud scanning services, the method comprising:
transmitting a registration request including a device type included in the device among cloud printing functions and cloud scanning functions to the cloud print server system that handles the cloud printing services and the cloud scanning services; and
acquiring, from the cloud print server system, an access token for a service enabled among the cloud printing services and the cloud scanning services.
